(19) United States
(12) Patent Application Publication
(10) Pub. No.: US 2012/0153530 A1
(43) Pub. Date: Jun. 21, 2012

(54) EXTRUSION HEAD ASSEMBLY AND RELATED METHODS

(76) Inventor: Hans Groeblacher, Mcpherson, KS (US)

(21) Appl. No.: 13/377,790

(22) PCT Filed: Jun. 11, 2010
(86) PCT No.: PCT/US10/38407

§ 371 Date: Mar. 5, 2012

Related U.S. Application Data
(60) Provisional application No. 61/186,367, filed on Jun. 11, 2009.

(51) Int. Cl. B29C 47/06; B29C 47/20

(52) U.S. Cl. 264/176.1; 425/133.1

(57) ABSTRACT

An improved extrusion head assembly is provided. One embodiment of the head assembly includes a pipe and profile co-extrusion head assembly with an integrated co-extrusion adapter. Another embodiment includes a double compression extrusion head for pipe extrusion. Still another embodiment includes a precision adjustment adapter for mounting a die/bushing to extrusion head assembly

### CROSS-REFERENCE TO RELATED APPLICATIONS

This application claims priority pursuant to co-pending U.S. Provisional Patent Application Ser. No. 61/186,367, filed Jun. 11, 2009, the entire disclosure of which is incorporated herein by reference.

### FIELD OF THE INVENTION

The present invention relates generally to an extrusion head assembly for creating plastic conduit/pipe and other objects having a fixed cross-sectional profile. More particularly, the present invention relates to improved mono and co-extrusion head assemblies, and a die/bushing adjustment assembly for an extrusion head assembly, and methods related thereto.

### BACKGROUND OF THE INVENTION

Extrusion is a process used to create objects of a fixed cross-sectional profile. A material is pushed or drawn through a die of the desired cross-section. Extrusion processes are particularly useful to create very complex cross-sections and/or to work materials that are brittle, because the material only encounters compressive and shear stresses. Extrusion processes may utilize a single material (i.e. “mono” extrusion), or may utilize two or more different materials extruded simultaneously to create single or multi-layered, objects.

An extrusion system for pipe or profile extrusion typically includes the following components:

A Material handling system

A Material loading system mounted to extruder feed section

An Extruder (single or twin screw)

A Calibration table (for profile-extrusion) or vacuum cooling tank (for pipe extrusion)

Cooling tank(s)

A Haul-off unit (Flat or contour belt for profile, 4+ belts for pipe)

A Cut-off Saw

A Tip or Dump table/Collection station

The material being extruded, such as a plastic material (in granular or powder form), is conveyed to the extruder feed hopper by the material handling system and gravity fed into the screw feed section of the extruder via the material loading system. The extruder screw(s) are located inside the extruder barrel. The extruder screw(s) convey the plastic material towards the exit of the extruder, and apply shear as well as heat to plasticize the material. The plasticized material will exit the extruder through the extrusion head and ultimately through an extrusion die attached to the head assembly. The extrusion die pre-forms the material into the desired shape (i.e. Pipe/Profile/Sheet/etc.). The cooling and shaping (calibration) of the pre-formed material takes place in a vacuum sizing unit (sizing sleeve for pipe, calibration system for profile). The calibrated product is cut to length by passing through a cut-off saw unit and collected on a Tip or Dump table.

In addition, when hollow shapes are extruded, such as pipes (i.e. circular cross-section) or other cross-sectional profiles, a mandrel is suspended within the head assembly to create the hollow shape by diverting the flow of the plasticized material around the outer surface of the mandrel. A typical extrusion head assembly further includes a melt inlet adapter (or adapters when co-extruding) for receiving the material from the extruder screw(s), a spider plate for supporting the mandrel and directing the flow of material around the surface of the mandrel, an inventory section for collecting material prior to shaping through the die, and an extrusion tooling adapter plate on which an extrusion die is attached.

Problems commonly encountered in the plastics extrusion industry include uneven wall thicknesses and markings on the insides of pipe (or other hollow profiles), which tend to reduce pipe pressure resistance, among other things. To overcome these and other problems, current plastics extrusion practice is to use more material to compensate for variations in wall thicknesses and similar inconsistencies. Moreover, making adjustments to the wall thickness of plastic pipes during the extrusion process is difficult and time consuming. In the case of conventional co-extrusion heads, the location of the co-extrusion adapter (typically between the extruder screw and the head assembly) requires a relatively high melt pressure of the plastic material, and relatively large and bulky machine components. In addition, the co-extruded layer is interrupted by the suspended mandrel in the die head, leading to quality issues with the co-extruded layer.

### SUMMARY OF THE INVENTION

Shortcomings with aspects of conventional extrusion heads and methods are addressed by the present invention as shown and described in a variety of illustrative embodiments herein. The pipe and profile extrusion head assembly described herein involves multiple aspects that, when utilized together, will significantly increase efficiency in the plastics extrusion industry. Nevertheless, each individual aspect described herein achieves reduction of production scrap, reduction of raw material usage, reduction of water and energy usage, positive impact on the environment, and/or reduction of negative ecological impact by the industry as a whole. Therefore, it will be appreciated that aspects of various embodiments disclosed herein may be utilized alone, or in combination with other aspects of other embodiments without departing from the spirit and scope of the instant invention and regardless of whether such specific combinations are specifically set forth herein.

One embodiment of the instant invention includes a pipe and profile co-extrusion head assembly with an integrated co-extrusion adapter. Another embodiment of the instant invention includes a double compression extrusion head for pipe extrusion. Still another embodiment of the instant invention includes a precision adjustment adapter for mounting a die/bushing to an extrusion head assembly. It will be appreciated that each of the three embodiments discussed above may be utilized independent of the other two embodiments, or may include aspects of one or both of the other two embodiments. For example, the integrated co-extrusion adapter embodiment may also include aspects of double compression and/or the precision adjustment adapter. The double compression embodiment may include aspects of the integrated co-extrusion adapter and/or the precision adjustment adapter. The precision adjustment adapter may include aspects of the integrated co-extrusion adapter and/or double compression. Moreover, it will be appreciated that in some embodiments, various components described herein may be modular or interchangeable with each other to allow certain aspects of different embodiments discussed herein to be combined together in a variety of different alternatives.

The co-extrusion head assemblies described herein provide significant extrusion head volume reduction (up to 600%) compared to PVC pipe extrusion heads of the prior art. The overall size of the co-ex head assembly of the instant invention is 5 to 6 times smaller than prior art designs due to the streamlined design of the flow channels, particularly when utilized in combination with the double compression aspect of the instant invention discussed below. The streamlined flow channel result in a uniform melt flow with low shear rate. The shear rate of the instant invention is reduced up to 50% over that of the prior art, allowing for up to a 100% increase in output rate for fence and decking profiles.

The precision adjustment adapter discussed herein, allows for a quick change-over (typically less than 15 minutes) from one profile or material to another profile or material. The precision adjustment adapter maintains previous wall thickness adjustments during die changes, such that a new die/bushing merely needs to be bolted to the mount plate. The extrusion head assembly of the embodiments shown herein are easily disassembled and cleaned, while still attached to the extruder, and wall thickness information remains fixed due to the precision adjustment adapter.

An extensive range of substrates can be extruded with the co-extrusion head assembly of the instant invention as the flow channels are all in the line of sight with no hidden features. This allows for virtually any surface finish application to be utilized during the extrusion process, including but not limit to heat treated and polished steel, deep nitride and polished, hard chrome-plated and polished, CVD diamond deposition

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations, and any feature that is described in a connection to any one embodiment may also be applicable to any other embodiment. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a side view of an “mono” extrusion line in which head assembly embodiments the instant invention may be utilized.

FIG. 2 is a side view of a co-extrusion line in which head assembly embodiments the instant invention may be utilized.

FIG. 3 is a section view of a mono extrusion head/die assembly of the prior art.

FIG. 4 is a section view of a co-extrusion head/die assembly of the prior art.

FIG. 5 is an exploded rear-end perspective view of an embodiment of a co-extrusion head assembly with an integrated co-extrusion adapter of the instant invention.

FIG. 6 is a front-end elevation view of the head assembly of FIG. 5.

FIG. 7 is a partial cross-section view of the head assembly of FIG. 5 taken along section D-D of FIG. 6.

FIG. 8 is an exploded perspective view of another embodiment of a co-extrusion head assembly of the instant invention.

FIG. 9 is an exploded perspective view of another embodiment of a co-extrusion head assembly of the instant invention.

FIG. 10 is an exploded perspective view of an embodiment of a mono extrusion head assembly of the instant invention.

FIG. 11 is an exploded perspective view of another embodiment of a mono extrusion head assembly of the instant invention.

FIG. 12 is a cross-section view of the head assembly of FIG. 11.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In the following detailed description of the preferred embodiments, reference is made to the accompanying drawings that form a part hereof and in which is shown, by way of illustration, specific embodiments in which the invention may be practiced. These embodiments are described in sufficient detail to enable those skilled in the art to practice the invention, and it is understood that other embodiments may be utilized and that logical structural, mechanical, electrical, and/or chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

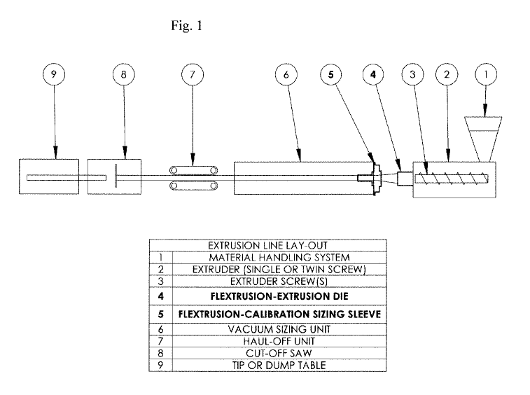

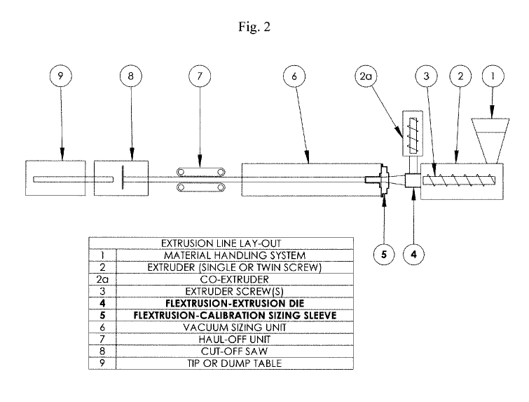

FIGS. 1 and 2 show exemplary embodiments of extrusion lines in which the head assembly and methods of the instant invention are utilized. FIG. 1 shows a “mono” extrusion line in which one layer of material is extruded, while FIG. 2 shows a co-extrusion line in which two layers of material are extruded, to form a conduit or other profile object. Referring to FIG. 1, material handling system 1, provides the material being extruded to extruder 2. The screw (or screws), 3, of extruder 2 pushes the material through the extruder head/die assembly 4 of the instant invention (discussed in further detail below) which is attached to the outlet of extruder 2. The extrusion die pre-forms the material into the desired shape (i.e. Pipe/Profile/Sheet/etc.). The cooling and shaping (calibration) of the pre-formed material takes place in a calibration sleeve 5 that is located at an opening of a vacuum sizing unit 6. The calibrated product is transported from the outlet of vacuum sizing unit 6 via haul-off unit 7 to cut-off saw 8 where it is cut to length by passing through a cut-off saw and then collected on a Tip or Dump table 9. Referring to FIG. 2, material handling system 1, provides a first material being extruded to extruder 2. The material handling system, or an additional material handling system, provides a second material being extruded to co-extruder 2a, which includes either a single or twin extruder screw(s). The screw (or screws), 3, of extruders 2 and 2a push the material through the co-extruder head/die assembly 4 of the instant invention (discussed in further detail below) which is attached to the outlet of extruder 2. The extrusion die pre-forms the material into the desired shape (i.e. Pipe/Profile/Sheet/etc.). The cooling and shaping (calibration) of the pre-formed material takes place in a calibration sleeve 5 that is located at an opening of a vacuum sizing unit 6. The calibrated product is transported from the outlet of vacuum sizing unit 6 via haul-off unit 7 to cut-off saw 8 where it is cut to length by passing through a cut-off saw and then collected on a Tip or Dump table 9.

### Co-Extrusion Head Assembly With an Integrated Co-Extrusion Adapter, Double Compression and Precision Adjustment Adapter

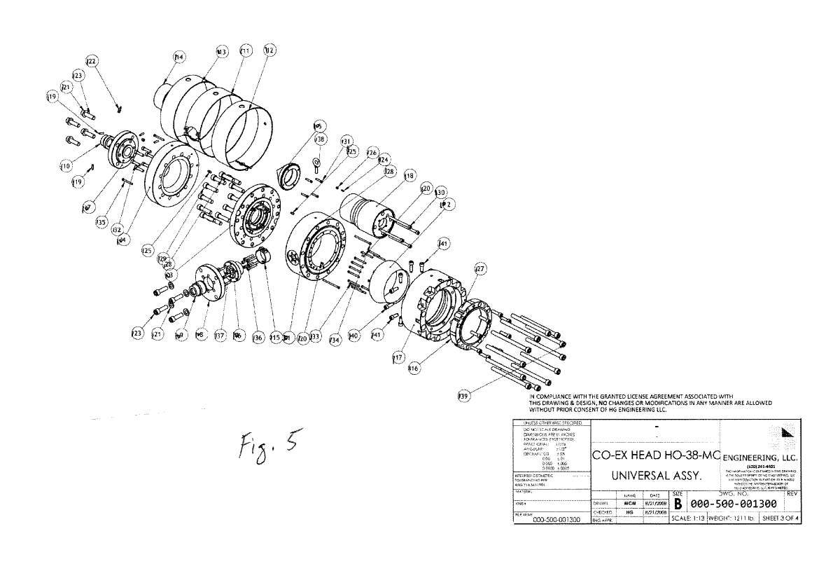

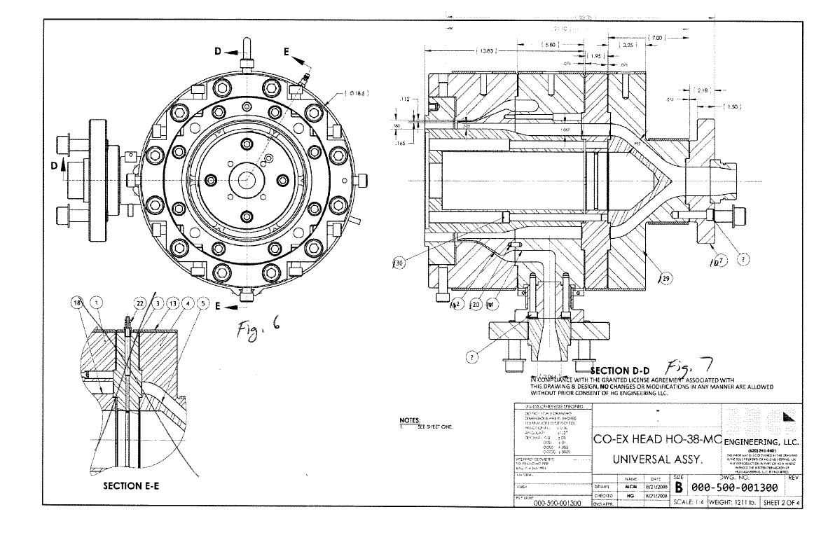

Referring to FIGS. 5-8, several embodiments of varying sizes of co-extrusion head assemblies with an integrated co-extrusion adapter of the instant invention are shown and described. Each embodiment of the co-extrusion head assembly shown herein also includes the inventive double compression feature, and the inventive precision adjustment adapter for mounting a die/bushing to an extrusion head assembly. Nevertheless, it will be appreciated that embodiments of the co-extrusion head assembly of the instant invention may not include either the double compression feature or the precision adjustment adapter of the instant invention, or may include only one or the other of the two. Furthermore, it will be appreciated that the double compression feature and/or the precision adjustment adapter may each (or both) be utilized in connection with any extrusion head assembly, including but not limited to any mono or co-extrusion head assemblies of the prior art, assemblies hereinafter developed, or the assemblies disclosed herein.

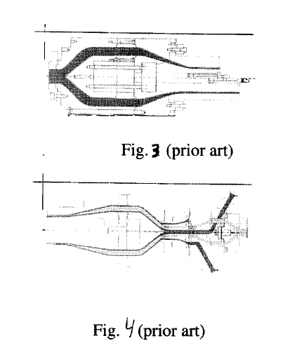

Referring to FIGS. 3 and 4, extrusion head/die assemblies of the prior art are shown. FIG. 3 shows a prior art extrusion head assembly in which a single layer of material is being extruded. As is shown in FIG. 3, the material being extruded is pushed through the inlet adapter by the extruder screw (not shown), through a spider plate and mandrel located in the inventory section of the extrusion head. The material is then compressed (single compression) through an extrusion die mounted on an extrusion tooling adaptor plate. As is shown in FIG. 4, three different materials are pushed into separate melt inlets of the head. All three materials are pushed through the spider plate and around the mandrel. The materials are then compressed (single compression) through the die in the same/similar manner as discussed above with respect to FIG. 3. As has been discussed previously, this relatively long and complex flow path for all three materials is the cause of relatively high melt pressure of the plastic material, requires relatively large and bulky extruder head components, leads to quality issues with the co-extruded layer(s) due to the interrupted flow path around the mandrel, and is the cause of material degradation.

### Co-Ex Head HO-38-MC Universal Assy.

Referring to FIGS. 5-7, one embodiment of a co-extrusion universal extrusion head assembly is shown that is particularly suited for extruding circular pipe having a diameter of 3 to 8 inches, or non-circular cross-sectional profiles having sides of 3 to 8 inches in length. Notwithstanding, it will be appreciated that a person of ordinary skill in the art will be capable of resizing and/or reshaping one or more of the components described herein to design a co-extrusion head assembly capable of making any size of pipe or profile desirable, as well as capable of making differing size ranges of pipe or profile than those discussed herein.

FIG. 5 shows an exploded view of the co-ex head assembly. FIG. 6 shows an end view of the co-ex head assembly. FIG. 7 shows cross-sectional view taken along section D-D of FIG. 6.

The co-extrusion universal extrusion head assembly, as shown in FIGS. 5-7, includes a co-ex plate 101, a pin 102, a bushing plate 117, a mount plate 116, a spider plate 103, an inlet bushing, 104, a co-ex inlet flange 107, a first orifice adapter 110, a tee adapter 106, an inlet flange 108, a second orifice adapter 109, a spider cone 105, a mandrel 118, and heater bands 111, 112, 113, 114 and 115.

The first orifice adapter 110 is affixed to the co-ex inlet flange 107, preferably with grade 8 socket head cap screws (SHCS) 123 and SAE washers 121. The first orifice adapter 110 is sized and shaped such that a plastic material to be extruded as the inner layer of the pipe or profile being co-extruded may be fed into the co-extrusion head assembly via the co-ex inlet flange 107. The material fed through adapter 110 flows through a spider plate and mandrel of the head assembly in a direction generally parallel with the direction of flow through a die attached to the head assembly. The co-ex inlet flange 107 further includes a coupling 122, which is an air supply fitting (coupling) used for line start-up. The co-ex inlet flange 107 further includes one or more thermocouple(s) (“T/C”) Adapter 119, preferably ⅛ NPT (National Pipe Thread) by 1.5 inches in length. The co-ex inlet flange 107 is affixed to the inlet bushing 104, preferably with SHCS 132 and 135. The inlet bushing 104 is aligned with the spider plate 103 by use of a bullet-nose dowel pin 125 and the inlet bushing 114 is affixed to the spider plate 103, preferably with the SHCS 129. The spider plate 103 further includes a dowel pin bushing 128. The spider plate 103 is affixed to the co-ex plate 101 via SHCS 129. The spider plate 103 is aligned with the co-ex plate 101 by use of a bullet-nose dowel pin 125. The co-ex plate 101 further includes an eyebolt 138 and one or more TIC Adapter 119, preferably ⅛ NPT (National Pipe Thread) by 1.5 inches in length. The co-ex plate 101 further includes one or more pull dowel pins 120 used to precisely locate parts to each other. The pin 102 is affixed to the co-ex plate 101, preferably with SHCS 133 and 134. The bushing plate 117 is affixed to the co-ex plate 101, preferably with SHCS 139. A mount plate 116 is situated within the bushing plate 117, includes a bushing 127, and affixed, preferably with SHCS 139 and 142. Adjustment screws 140 and 141 are further included to fine tune the alignment of the mount plate 116 (on which a die assembly, not shown, may be mounted—i.e. this is the precision adjustment adapter) within the bushing plate 117. Heater bands 111, 112, 113 and 114 are included to surround the co-ex inlet flange 107, inlet bushing 104, spider plate 103, co-ex plate 101 and bushing plate 117. A pin-spider 105 is affixed to the inlet side of the spider plate 103 and extends within the inlet bushing 104. The pin-spider 105 is preferably affixed to the spider plate 103 with SHCS 131. The mandrel 118 is affixed to the other side (outlet side) of the spider plate 103, preferably with SHCS 130, and extends within the co-ex plate 101. The mandrel 118 is aligned with the spider plate 103 by use of a bullet-nose dowel pin 124. The mandrel 118 further includes bushing 126. The co-ex plate 101 further includes a co-ex inlet. The tee adapter 106 is affixed to the co-ex plate 101, preferably with SHCS 136. The flange 108 is affixed to the tee adapter 106, preferably with SHCS 137. The second orifice adapter 109 is affixed to the flange 108, preferably with SHCS 123 and washers 121. The second orifice adapter 109 is sized and shaped such that a second plastic material to be extruded as the outer layer of the pipe or profile being co-extruded may be fed into the co-extrusion head assembly at the co-ex plate 101 via the flange 108. The second orifice adapter 109 co-extrusion adapter feeds material into the head in a direction generally perpendicular with the direction of flow through the die and after the spider plate such that the material does not feed through the spider plate.

As is shown in FIG. 7, the co-ex head assembly of FIG. 5 is structured to utilize the double-compression feature of the instant invention. The first and second materials being co-extruded are fed into the co-extrusion head assembly in the manner discussed above. As the first material is fed through the co-ex head assembly, it is compressed between the inner surface of the head assembly and the outer surface of the mandrel due to a decrease in the gap between the inner surface of the head assembly and the outer surface of the mandrel. Referring to FIG. 7, the decrease in gap occurs near the transition between the co-ex plate and the bushing plate (generally within the bushing plate). In the embodiment shown in FIG. 7, the gap (or flow path) decreases from approximately 1.057 inches in the co-ex plate, to 0.503 inches in the bushing plate. Similarly, as the second material is fed into the co-extrusion head assembly in the manner discussed above, it is also compressed. The compression occurs through a decrease in the dimension of the flow channel of the second material through the bushing plate. At or near the point in the bushing plate in which the first and second materials are brought together (co-extruded), the dimension of the flow path is increased or expanded to a dimension that is larger than the sum of the two compressed flow paths for the first and second materials. In the embodiment shown in FIG. 7, the compressed flow path of the second material is 0.112 inches, and the expanded dimension of the combined flow paths is 0.780, a total expansion of 0.165 inches (expansion zone). The co-extruded materials are then compressed a second time as they are fed through the die (not shown) that is attached to the bushing plate via the mounting plate in the manner described above. It will be appreciate that the amount of compression and/or expansion taking place in either the first or second compressions (compression zones) may vary significantly depending upon the materials being extruded, the size or shape of the part being extruded, or a variety of other variables that will become apparent to a person of ordinary skill in the art utilizing the teaching of the instant invention.

### HO-25-MC Die & Head With Coex

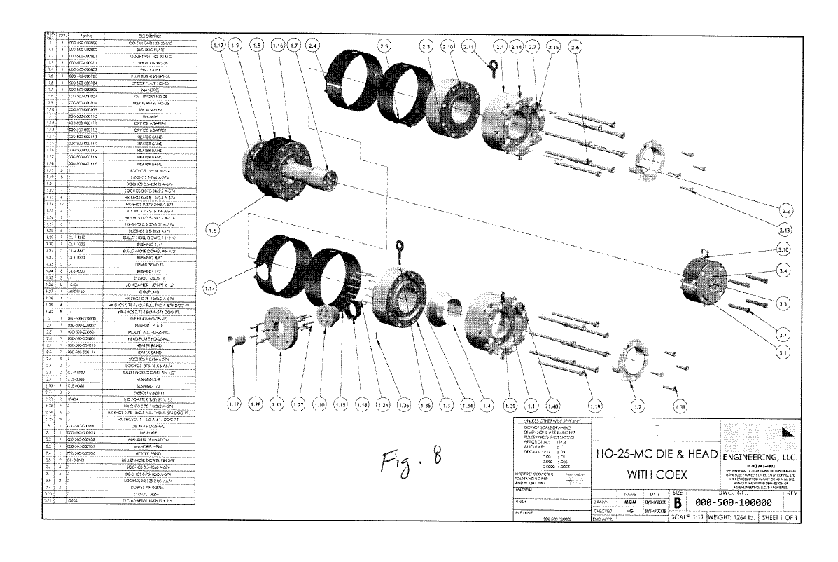

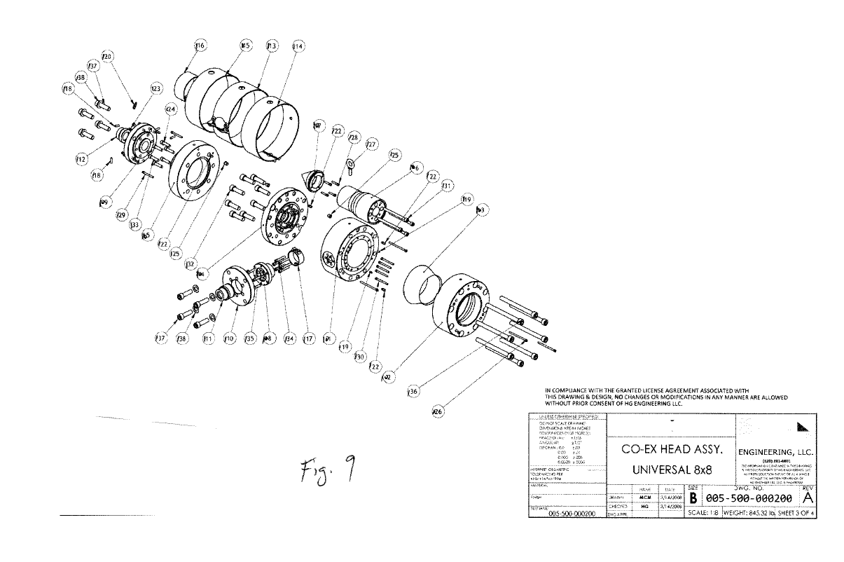

Referring to FIG. 8, another embodiment of a co-extrusion universal extrusion head assembly is shown that is particularly suited for extruding circular pipe having a diameter of 2 to 5 inches, or non-circular cross-sectional profiles having sides of 2 to 5 inches in length. Notwithstanding, it will be appreciated that a person of ordinary skill in the art will be capable or resizing and/or reshaping one or more of the components described herein to design a co-extrusion head assembly capable of making any size of pipe or profile desirable, as well as capable of making differing size ranges of pipe or profile than those discussed herein.

According to the embodiment shown in FIG. 8, a universal extrusion head assembly to be used alternatively with either a co-extrusion head or with a mono-extrusion head is provided. FIG. 8 shows an exploded view of the universal extrusion head assembly with both alternatives. The embodiment shown in FIG. 8 provides a modular, design for a universal extrusion head with exchangable pieces for co-extrusion or mono-extrusion.

The universal extrusion head assembly, as shown in FIG. 8, includes an inlet bushing 1.5, a spider plate 1.6, a mandrel 1.7, a pin spider (1.8 not shown), an inlet flange 1.9, a first orifice adapter (inlet—1.13 not shown), and heater bands 1.16 and 1.17. The co-extrusion head includes a bushing plate 1.1, a mount plate 1.2, a co-ex plate 1.3, a pin 1.4, a tee adapter 1.10, a flange 1.11, a second orifice adapter 1.12, and heater bands 1.14, 1.15, and 1.18. The die and die head includes a bushing plate 2.1, a mount plate 2.2, a die head plate 2.3, a die plate 3.1, a mandrel transition 3.2 (not shown), a mandrel exit 3.3 and heater bands 2.4, 2.5, and 3.4.

The first orifice adapter 1.13 (not shown) is affixed to the inlet flange 1.9, preferably with grade 8 socket head cap screws (SHCS) and SAE washers. The first orifice adapter 1.13 is sized and shaped such that a plastic material to be extruded may be fed into the universal head assembly via the inlet flange 1.9. The inlet flange 1.9 further includes a coupling, which is an air supply fitting (coupling) used for line start-up. The inlet flange 1.9 further includes one or more T/C Adapter 1.36. The inlet flange 1.9 is affixed to the inlet bushing 1.5, preferably with SHCS. The inlet bushing 1.5 is aligned with the spider plate 1.6 by use of a bullet-nose dowel pin and the inlet bushing 1.5 is affixed to the spider plate 1.6, preferably with SHCS 1.24. The spider plate 1.6 further includes a bushing 1.34, which is the female part of the pull out dowel pin. A pin-spider 1.8 (not shown) is affixed to the inlet side of the spider plate 1.6 and extends within the inlet bushing 1.5. The mandrel 1.7 is affixed to the other side (outlet side) of the spider plate 1.6. The mandrel 1.7 is aligned with the spider plate 1.6 by use of a bullet-nose dowel pin 1.29 (not shown). The mandrel 1.7 further includes bushing 1.30 (not shown).

As a first alternative, a co-extrusion head may be affixed to the universal head. The spider plate 1.6 is affixed to the co-ex plate 1.3 via SHCS 1.24. The spider plate 1.6 is aligned with the co-ex plate 1.3 by use of a bullet-nose dowel pin. The co-ex plate 1.3 further includes an eyebolt 1.35 and one or more T/C Adapter 1.36. The pin 1.4 is affixed to the co-ex plate 1.3. The bushing plate 1.1 is affixed to the co-ex plate 1.3, preferably with SHCS 1.19. The mount plate 1.2 is situated within the bushing plate 1.1, includes a bushing 1.32, and affixed, preferably with SHCS 1.19 and 1.38. Adjustment screws 1.39 and 1.40 are further included to fine tune the alignment of the mount plate 1.2 within the bushing plate 1.1. Heater band 1.17 surrounds the inlet flange 1.9 and inlet bushing 1.5. Heater band 1.16 surrounds the spider plate 1.6. Heater band 1.14 surrounds the co-ex plate 1.3. Heater band 1.15 surrounds the bushing plate 1.1 and mount plate 1.2.

The co-ex plate 1.3 further includes a co-ex inlet. The tee adapter 1.10 is affixed to the co-ex plate 1.3, preferably with SHCS 1.27. The flange 1.11 is affixed to the tee adapter 1.10, preferably with SHCS 1.28. The second orifice adapter 1.12 is affixed to the flange 1.11, preferably with SHCS and SAE washers. The second orifice adapter 1.12 is sized and shaped such that a second plastic material to be extruded may be fed into the co-extrusion head assembly at the co-ex plate 1.3 via the flange 1.11 Heater band 1.18 surrounds the tee adapter 1.10 and flange 1.11

As a second alternative, the co-extrusion head may be exchanged for the mono extrusion head. The spider plate 1.6 is affixed to the die head plate 2.3. The spider plate 1.6 is aligned with the die head plate 2.3 by use of a bullet-nose dowel pin. The die head plate 2.3 further includes an eyebolt 2.11 and one or more T/C Adapter 2.12. The bushing plate 2.1 is affixed to the die head plate 2.3, preferably with SHCS 2.6 and 2.7. The mount plate 2.2 is situated within the bushing plate 2.1, includes a bushing 2.10, and affixed, preferably with SHCS 2.13. Adjustment screws 2.14 and 2.15 are further included to fine tune the alignment of the mount plate 2.2 within the bushing plate 2.1. Heater band 2.4 surrounds the die head plate 2.3. Heater band 2.5 surrounds the bushing plate 2.1 and mount plate 2.2.

The die is affixed to the mandrel 1.7. The die plate 3.1 is affixed to the mandrel 1.7 via the mandrel transition 3.2 (not shown). The die plate 3.1 includes an eyebolt 3.10. The die plate 3.1 is surrounded by heater band 3.4. The die plate 3.1 further includes the mandrel exit 3.3.

### Method of Assembly/Disassembly

According to another illustrative embodiment shown in a method of assembling/disassembling (or manufacturing) the a co-extrusion head assemblies described above is provided.

The first step in the method of manufacturing a co-extrusion head assembly is affixing a pin-spider (or spider cone) to the inlet side of the spider plate. The spider plate includes a coupling. The second step is to affix the inlet side of the spider plate to an inlet bushing. The inlet bushing includes an eyebolt, T/C adapter, and heater band. The third step is to affix the co-ex inlet flange to the inlet bushing. The inlet bushing and spider plate are surrounded with a heater band. The fourth step is to affix the mandrel to the outlet side of the spider plate. The fifth step is to affix the tee adapter to the co-ex plate. The tee adapter includes a T/C adapter and is surrounded by a heater band. The sixth step is to affix the flange to the tee adapter. The seventh step is to affix the pin to the outlet side of the co-ex plate. The eighth step is to affix the inlet side of the co-ex plate to the outlet side of the spider plate, with the mandrel extending within the co-ex plate and pin. The ninth step is to affix the bushing plate to the co-ex plate with the pin and mandrel extending through the bushing plate. The bushing plate and co-ex plate are each surrounded by a heater band. The co-ex plate and bushing plate may optionally include an eyebolt.

The co-extrusion head assemblies described above provide significant extrusion head volume reduction (up to 600%) compared to PVC pipe extrusion heads of the prior art. The overall size of the co-ex head assembly of the instant invention is 5 to 6 times smaller than prior art designs due to the streamlined design of the flow channels, particularly when utilized in combination with the double compression aspect of the instant invention discussed below. The streamlined flow channel result in a uniform melt flow with low shear rate. The shear rate of the instant invention is reduced up to 50% over that of the prior art, allowing for up to a 100% increase in output rate for fence and decking profiles.

The precision adjustment adapter discussed above, allows for a quick change-over (typically less than 15 minutes) from one profile or material to another profile or material. The precision adjustment adapter maintains previous wall thickness adjustments during die changes, such that a new die/bushing merely needs to be bolted to the mount plate. The extrusion head assembly of the embodiments shown herein are easily disassembled and cleaned, while still attached to the extruder, and wall thickness information remains fixed due to the precision adjustment adapter.

An extensive range of substrates can be extruded with the co-extrusion head assembly of the instant invention as the flow channels are all in the line of sight with no hidden features. This allows for virtually any surface finish application to be utilized during the extrusion process, including but not limit to heat treated and polished steel, deep nitride and polished, hard chrome-plated and polished, CVD diamond deposition.

### Alternative Embodiment Co-Ex

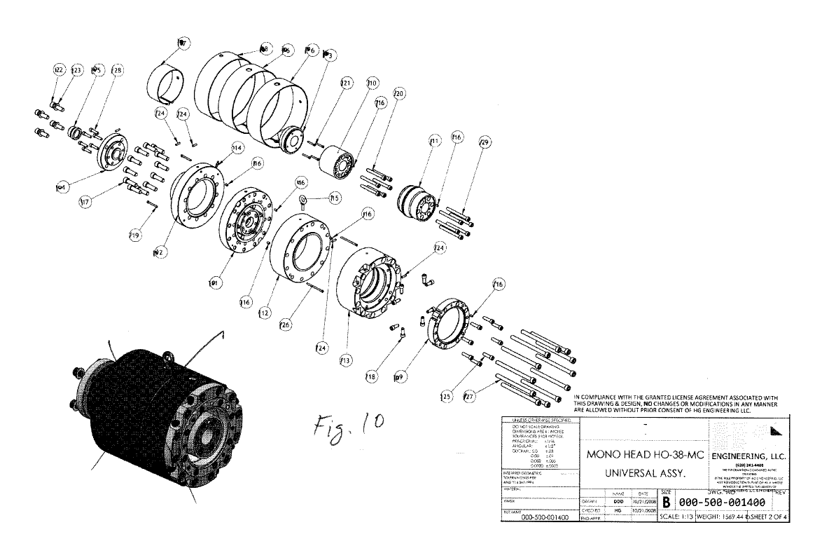

Referring to FIG. 9, another embodiment of a co-extrusion universal extrusion head assembly is shown. FIG. 9 shows an exploded perspective view of the co-extrusion universal extrusion head assembly.

### Double Compression Extrusion Head and Precision Adjustment Adapter

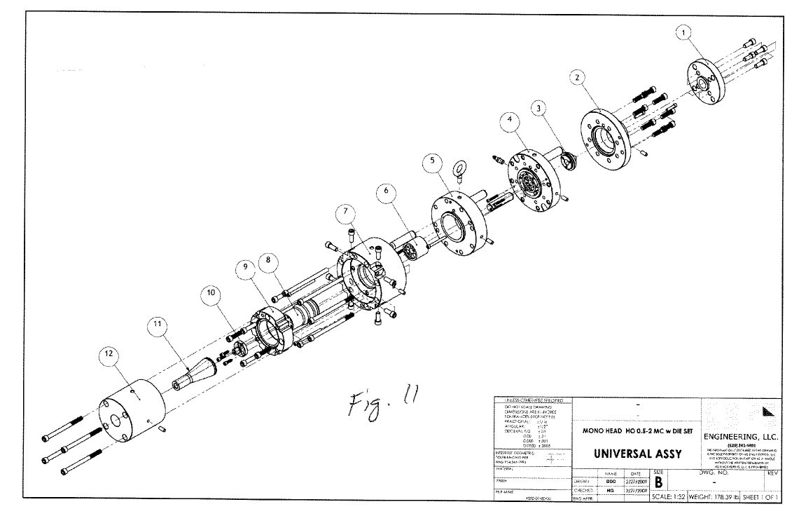

Referring to FIGS. 10-12, two embodiments of a mono-extrusion head assembly of the instant invention are shown and described that include the double compression aspect of the instant invention. The amount of compression and expansion shown in the embodiments of FIGS. 10-12 are more extensive than those described above with respect to the co-extrusion head assembly. Nevertheless, it will be appreciated that the amount of compression and/or expansion taking place in either the first or second compressions may vary significantly depending upon the materials being extruded, the size or shape of the part being extruded, or a variety of other variables that will become apparent to a person of ordinary skill in the art utilizing the teaching of the instant invention. In addition, both embodiments shown in FIGS. 10-12 include the precision adjustment adapter discussed above.

### Mono Head HO-38-MC Universal Assembly

Referring to FIG. 10, an embodiment of a mono-extrusion universal extrusion head assembly is shown that is particularly suited for extruding circular pipe having a diameter of 3 to 8 inches, or non-circular cross-sectional profiles having sides of 3 to 8 inches in length. Notwithstanding, it will be appreciated that a person of ordinary skill in the art will be capable or resizing and/or reshaping one or more of the components described herein to design an extrusion head assembly capable of making any size of pipe or profile desirable, as well as capable of making differing size ranges of pipe or profile than those discussed herein.

The mono-head universal extrusion head assembly, as shown in FIG. 10, includes a compression plate 13, mount plate 9, inventory plate 12, spider plate 1, inlet bushing 2, inlet flange 4, orifice adapter 5, mandrel 11, mandrel extension 10, spider cone 3, and heater bands 6, 7 and 8. The orifice adapter 5 is affixed to the inlet flange 4, preferably with grade 8 socket head cap screws (SHCS) 22 and SAE washers 23. The orifice adapter 5 is sized and shaped such that a plastic material to be extruded may be fed into the extrusion head assembly via the inlet flange 4. The inlet flange 4 is affixed to the inlet bushing 2, preferably with SHCS 17 and 19. The inlet flange 4 and inlet bushing 2 further include one or more T/C Adapter 24, preferably ⅛ NPT (National Pipe Thread) by 1.5 inches in length. The inlet bushing 2 further includes a hose coupling plug 14, preferably a ¼ inch hose coupling plug available as McMASTER part number 6050T140. The inlet bushing 2 is aligned with a spider plate 1 by use of a pull dowel pin 16 and the inlet bushing 2 is affixed to the spider plate 1, preferably with the SHCS 17 and 19. The spider plate 1 is affixed to the inventory plate 12 via SHCS 27. The spider plate 1 is aligned with the inventory plate 12 by use of a pull dowel pin 16. The inventory plate 12 further includes an eyebolt 15 and one or more T/C Adapter 24, preferably ⅛ NPT (National Pipe Thread) by 1.5 inches in length. The compression plate 13 is affixed to the inventory plate 12, preferably with SHCS 26 and 27. The compression plate 13 further includes one or more T/C Adapter 24, preferably ⅛ NPT (National Pipe Thread) by 1.5 inches in length. A mount plate 9 is situated within the compression plate 13, aligned by use of a pull dowel pin 16 and affixed, preferably with SHCS 25. Adjustment screws 18 are further included to fine tune the alignment of the mount plate 9 (on which a die, not shown, is mounted—this is the precision adjustment adapter) within the compression plate 13. Heater bands 6, 7 and 8 are included to surround the inlet flange 4, inlet bushing 2, spider plate 1, inventory plate 12 and compression plate 13. A spider cone 3 is affixed to the inlet side of the spider plate 1 and extends within the inlet bushing 2. The spider cone 3 is preferably affixed to the spider plate 1 with SHCS 21. The mandrel extension 10 is affixed to the other side (outlet side) of the spider plate 1, preferably with SHCS 20, and extends within the inventory plate 12. The mandrel extension 10 is aligned with the spider plate 2 by use of a pull dowel pin 16. The mandrel 11 is affixed to the mandrel extension 10, preferably with SHCS 29, and extends within the compression plate 13. The mandrel 11 is aligned with the mandrel extension 10 by use of a pull dowel pin 16.

### Mono Head HO-0.5-2 MC Universal Assembly

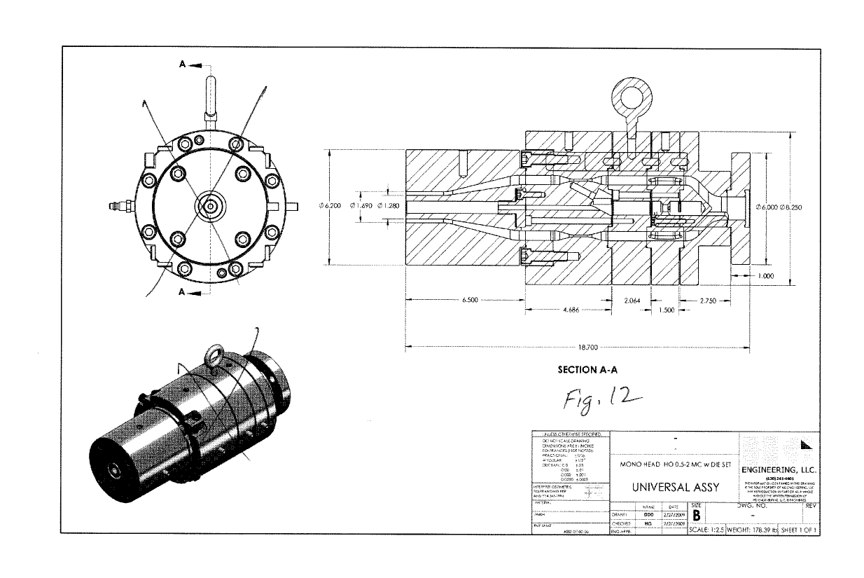

Referring to FIGS. 11 and 12, another embodiment of a mono-extrusion universal extrusion head assembly is shown that is particularly suited for extruding circular pipe having a diameter of 0.5 to 2 inches, or non-circular cross-sectional profiles having sides of 0.5 to 2 inches in length. Notwithstanding, it will be appreciated that a person of ordinary skill in the art will be capable or resizing and/or reshaping one or more of the components described herein to design an extrusion head assembly capable of making any size of pipe or profile desirable, as well as capable of making differing size ranges of pipe or profile than those discussed herein.

FIG. 11 shows a perspective exploded view of the mono-head universal extrusion head assembly with the inlet on the right and the die mounted on the left. FIG. 12 shows a sectional view A-A of the assembly of FIG. 11.

The mono-head universal extrusion head assembly, as shown in FIGS. 11 and 12, includes a compression plate 107, mount plate 109, inventory plate 105, spider plate 114, inlet bushing 102, inlet flange 101, mandrel 108, mandrel extension 106, spider cone 103. Die base 110 is mounted to mandrel 108 and die pin 111 is attached to die base 110. Die bushing 112 is mounted to mount plate 109, The position of die bushing 112 relative to die pin 111 is adjusted utilizing adjustment screws (shown but not numbered) that extend through compression plate 107 to adjust the position of mount plate 109 relative to compression plate 107. Adjusting the position of die bushing 112 allows the wall thickness of the piece being extruded to be controlled/adjusted.

Plastic material to be extruded may be fed into the extrusion head assembly through inlet flange 101. As can be seen in FIG. 12, the plastic material is diverted by spider cone 103 and fed through spider plate 104 and into inventory plate 105, which includes a bored-out center portion in which mandrel extension 106 is located. A gap between the outer surface of mandrel extension 106 and the inner surface of the bored cavity of inventory plate 105 creates a flow channel for the plastic material to flow as it is diverted by spider cone 103 and fed through spider plate 104. The flow channel is further defined by a gap created by an inner surface of a bored cavity of compression plate 107 and an outer surface of mandrel 108. As is shown in FIG. 12, the shape of mandrel 108 and the bore within compression plate 107 is such that the flow channel is compressed to a relatively narrow gap and then expanded back to a gap generally the same as the gap of the flow channel through inventory plate 105. The plastic then is fed through the die assembly, through a gap created by the outer surface of die pin 111 and the inner bore surface of die bushing 112. The shape of the die pin and die bushing is such that the flow channel is again compressed as the plastic is fed through the die assembly. This results in a “double compression” of the plastic material. The first compression that occurs between the compression plate 107 and mandrel 108 “reconnects” or compresses/fuses together into a single mass, the plastic material, which has been disconnected or separated as it is directed through the spider plate 104. The second compression, that occurs in the die assembly, further fuses together the material into a single mass, resulting in a higher quality product that utilizes less material. This double compression method is particular well suited for extrusion of polyolefin and PEX pipe, nevertheless, it will be appreciated that other materials and profiles may be utilized without departing from the spirit and scope of the instant invention. It will further be appreciated that additional compression/expansion steps may be utilized (i.e. triple, quadruple, etc., compression) without departing from the spirit and scope of the instant invention.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. An extrusion head assembly comprising:
a head;
a first extrusion adapter at an end of said head for feeding a first layer of material into said head through a spider plate and mandrel; and
a second co-extrusion adapter integrated into said head for feeding a second layer of material into said head at a location after said spider plate.

2. The extrusion head assembly as claimed in claim 1 wherein said first layer comprises an inner layer for an object being co-extruded, and said second layer comprises an outer layer for the object being co-extruded.

3. The extrusion head assembly as claimed in claim 2 wherein the object comprises a pipe.

4. The extrusion head assembly as claimed in claim 2 wherein the object comprises a profile.

5. The extrusion head assembly as claimed in claim 1 wherein said first extrusion adapter feeds material into said head in a direction generally parallel with the direction of flow through a die of the head assembly.

6. The extrusion head assembly as claimed in claim 5 wherein said second co-extrusion adapter feeds material into said head in a direction generally perpendicular with the direction of flow through the die.

7. A method of co-extruding an object comprising the steps of:
feeding a first layer of material into an extrusion head through a spider plate and mandrel; and
feeding a second layer of material into said head at a location after said spider plate without feeding said second layer of material through said spider plate.

8. An extrusion head assembly comprising:
a bushing plate; and
a die removably attached to said bushing plate, said die including a compression zone in which a dimension of a flow path through said die is decreased;
wherein said bushing plate includes a compression zone in which a dimension of a flow path through said bushing plate is decreased, and also includes an expansion zone after said compression zone in which the dimension of the flow path through said bushing plate is increased; and
wherein said flow path through said bushing plate merges with said flow path through said die after said expansion zone of said bushing plate.

9. The extrusion head assembly as claimed in claim 8 further comprising a co-extrusion plate removably attached to said bushing plate.

10. The extrusion head assembly as claimed in claim 9 wherein said co-extrusion plate feeds a layer of material into said bushing plate at a location after a spider plate that is associated with said bushing plate.

11. An extrusion head assembly comprising:
a bushing or compression plate including a flow path through which a material being extruded is fed;
a mount plate adjustably attached to said bushing or compression plate such that alignment of said mount plate relative to said bushing or compression plate is adjustable; and
a die removably attached to said mount plate.

12. The extrusion head assembly as claimed in claim 11 further comprising adjustment screws for adjusting said alignment of said mount plate relative to said bushing or compression plate.

13. The extrusion head assembly as claimed in claim 11 wherein said mount plate is positioned within said bushing or compression plate.
